(19) United States
(12) Patent Application Publication
(10) Pub. No.: US 2025/0262777 A1
(43) Pub. Date: Aug. 21, 2025

(54) POSITIONING DEVICE

(71) Applicant: FANUC CORPORATION, Yamanashi (JP)

(72) Inventor: Hideki Kazama, Yamanashi (JP)

(21) Appl. No.: 19/194,292

(22) Filed: Apr. 30, 2025

Related U.S. Application Data
(63) Continuation of application No. PCT/JP2022/045345, filed on Dec. 8, 2022.

(51) Int. Cl. B25J 15/08

(52) U.S. Cl. CPC B25J 15/08

(57) ABSTRACT

A positioning device including a plurality of finger portions formed so as to be movable in a radial direction perpendicular to the axial direction and a wedge-shaped pressing member disposed so as to contact the plurality of finger portions. The positioning device further includes a moving device that moves the pressing member in the axial direction. By the moving device moving the pressing member in a state in which the finger portions are inserted into a plurality of hole portions of a workpiece, the finger portions are moved outward in the radial direction, thereby positioning the plurality of hole portions of the workpiece.

### CROSS-REFERENCE TO RELATED APPLICATIONS

This application is a bypass continuation application of International Application No. PCT/JP2022/045345 filed Dec. 8, 2022.

### BACKGROUND

### Field

The present disclosure relates to a positioning device.

### Discussion of the Related Art

In a process of manufacturing a product, there is a step in which, after stacking a plurality of workpieces, holes formed in the workpieces are positioned. For example, there is a case in which a plurality of workpieces are fixed to each other by inserting a bolt into holes after positioning of the holes. Alternatively, there is a case in which the positions of the holes are aligned with each other, and then a rod-shaped member such as a pin or a shaft is inserted into the holes of the workpieces.

When the positions of the plurality of holes are displaced from each other, a member such as a bolt or a shaft cannot be smoothly inserted into the holes in some cases. For this reason, when the holes are viewed from an axial direction, the positions of the plurality of holes need to coincide exactly with each other.

In the prior art, in order to align the positions of holes of a plurality of workpieces, there is known a device in which a hole clamp for holding the holes is inserted into the holes so as to align the positions of the holes with the clamping force. However, when the hole clamp is large, there is a case where the hole clamp may not be able to be inserted into the holes. Alternatively, there is known a method of using an air chuck in order to align the positions of holes of a plurality of workpieces. Fingers of the air chuck are inserted into the holes. Accordingly, there is known a device for positioning of holes by opening a plurality of such fingers.

In a device for aligning the positions of holes with each other by opening fingers of an air chuck, there is a case in which, when the diameter of the hole is small, a finger may be deformed or broken because the rigidity of the finger cannot be increased. Alternatively, also in a case where a large opening force of the air chuck is required, a finger may be deformed or broken. When a finger is broken, it needs to be replaced. As explained above, in the case where the air chuck is used as a device for positioning of the holes, there is a problem in that the durability of the device is low.

### SUMMARY

A positioning device according to an aspect of the present disclosure includes a plurality of fingers formed to be movable in a radial direction perpendicular to an axial direction, and a pressing member having a wedge shape and disposed so as to be in contact with the plurality of fingers. The positioning device further includes a movement device configured to move the pressing member in the axial direction. When the movement device moves the pressing member in a state in which the fingers are inserted into holes of a plurality of workpieces, the fingers move outward in the radial direction to align positions of the holes of the plurality of workpieces.

### BRIEF DESCRIPTION OF DRAWINGS

FIG. 1 is a schematic perspective view of a robot apparatus according to an embodiment.

FIG. 2 is a block diagram of the robot apparatus according to the embodiment.

FIG. 3 is a perspective view of a work tool according to the embodiment.

FIG. 4 is a schematic cross-sectional view of the work tool according to the embodiment.

FIG. 5 is an enlarged schematic cross-sectional view of a first step of aligning hole positions in the work tool according to the embodiment.

FIG. 6 is an enlarged schematic cross-sectional view of a second step of aligning hole positions in the work tool according to the embodiment.

FIG. 7 is an enlarged schematic cross-sectional view when the work tool according to the embodiment has adjusted the positions of the holes.

FIG. 8 is an enlarged schematic cross-sectional view of a first step of aligning hole positions in a positioning device according to a comparative example.

FIG. 9 is an enlarged schematic cross-sectional view of a second step of aligning hole positions in the positioning device according to the comparative example.

FIG. 10 is a plan view when two plate-shaped workpieces are stacked.

FIG. 11 is an enlarged view of an image of holes when two workpieces are stacked.

FIG. 12 is a schematic cross-sectional view of another positioning device according to the embodiment.

### DETAILED DESCRIPTION OF THE EMBODIMENTS

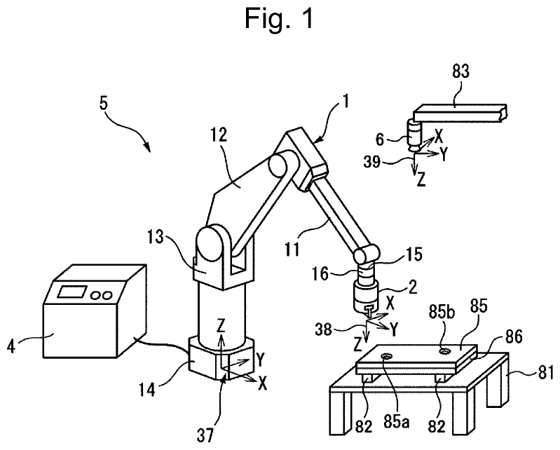

A positioning device and a robot apparatus including the positioning device and a robot in the embodiment will be described with reference to FIG. 1 to FIG. 12. The positioning device of the present embodiment adjusts relative positions of a plurality of workpieces so that the positions of holes formed in the workpieces are aligned with each other when the plurality of workpieces are stacked and arranged.

FIG. 1 is a perspective view of a robot apparatus in the present embodiment. A robot apparatus 5 of the present embodiment includes a robot 1 and a work tool 2. The robot apparatus 5 includes a controller 4 configured to control the robot 1 and the work tool 2. In the present embodiment, the work tool 2 attached to the robot 1 corresponds to a positioning device. The robot apparatus 5 changes the position and orientation of the positioning device, and inserts a finger of the positioning device into holes of a plurality of workpieces 85, 86. The positioning device then aligns the positions of the holes with each other.

The robot 1 of the present embodiment is an articulated robot including a plurality of joints. The robot 1 includes an upper arm 11 and a lower arm 12. The lower arm 12 is supported by a swivel base 13. The swivel base 13 is supported by a base 14. The robot 1 includes a wrist 15 connected to an end portion of the upper arm 11. The wrist 15 includes a flange 16 attached with the work tool 2 and formed to be rotatable.

These constituent members of the robot 1 are each formed so as to rotate about a predetermined rotation axis. The robot of the present embodiment has six drive axes, but is not limited to this configuration. The robot may employ any robot that can change the position and orientation of the work tool.

The work tool 2 of the present embodiment functions as a positioning device for aligning the positions of holes formed in a plurality of workpieces. The workpieces 85 and 86 of the present embodiment are each formed in a plate shape. The workpieces 85 and 86 are set on platforms 81 and 82. The workpieces 85 and 86 are each arranged so that an area-maximum surface having the largest area extends in a horizontal direction. As will be described later, holes 85a and 85b are formed in the workpiece 85. Holes 86a and 86b are formed in the workpiece 86.

In the present embodiment, the workpiece 85 and the workpiece 86 have the same shape. When the two workpieces 85 and 86 are stacked and viewed in a plan view, the position of the hole 85a and that of the hole 86a substantially coincide with each other. The hole 85a and the hole 86a have the same shape. The position of the hole 85b and the position of the hole 86b substantially coincide with each other. The hole 85b and the hole 86b have the same shape. However, the positions of the holes are slightly displaced from each other in a plan view in some cases.

The robot apparatus 5 of the present embodiment performs an operation of aligning a relative position of the workpiece 86 with respect to the workpiece 85 by using the work tool 2 so that the positions of the holes are coincident with each other in a plan view. Thereafter, an operation of inserting a member such as a bolt or a pin into the holes is performed by, for example, another robot apparatus.

The robot apparatus 5 of the present embodiment includes a camera 6 as a vision sensor for detecting the positions of the holes of the workpieces 85 and 86. The position of the camera 6 of the present embodiment is fixed by a support member 83. The camera 6 of the present embodiment is a two-dimensional camera. The camera 6 is controlled by a controller 4. The camera 6 of the present embodiment captures an image of the workpieces 85 and 86. The camera 6 is disposed so as to capture an image of an object located just under the camera. In other words, the camera 6 is fixed such that an optical axis extends in the vertical direction.

The distances from the workpieces 85 and 86 to the camera 6 are measured in advance. Because of this, a three-dimensional position can be detected based on a position in a two-dimensional image that the camera 6 captures. For example, a reference image 46 of the hole 85a can be stored in a storage part 42. Then, the three-dimensional position of the hole 85a can be detected by pattern matching of the image captured by the camera 6.

A reference coordinate system 37, which is immovable when a change in the position and orientation of the robot 1 occurs, is set in the robot apparatus 5 of the present embodiment. In the example illustrated in FIG. 1, the reference coordinate system 37 has the origin arranged at the base 14 of the robot 1. The reference coordinate system 37 is also referred to as a world coordinate system.

In the robot apparatus 5, a tool coordinate system 38 having the origin set at an arbitrary position of the work tool 2 is set. The tool coordinate system 38 changes the position and orientation together with the work tool 2. In the present embodiment, the origin of the tool coordinate system 38 is set at a tool center point.

When the position and the orientation of the robot 1 change, the position of the origin and the orientation of the tool coordinate system 38 change. The position of the robot 1 corresponds to the position of the tool center point (the position of the origin of the tool coordinate system 38). The orientation of the robot 1 corresponds to the orientation of the tool coordinate system 38 with respect to the reference coordinate system 37.

Further, in the robot apparatus 5, a camera coordinate system 39 is set with respect to the camera 6. The camera coordinate system 39 is a coordinate system in which the origin is fixed to the camera 6. In the present embodiment, since the position of the camera 6 is fixed, the position of the camera coordinate system 39 is likewise fixed. In the present embodiment, the camera coordinate system 39 is set such that the Z axis of the camera coordinate system 39 coincides with the optical axis.

Each of the coordinate systems has X axis, Y axis, and Z axis orthogonal to each other as the coordinate axes. In addition, W axis serving as a coordinate axis around the X axis, P axis serving as a coordinate axis around the Y axis, and R axis serving as a coordinate axis around the Z axis may be set.

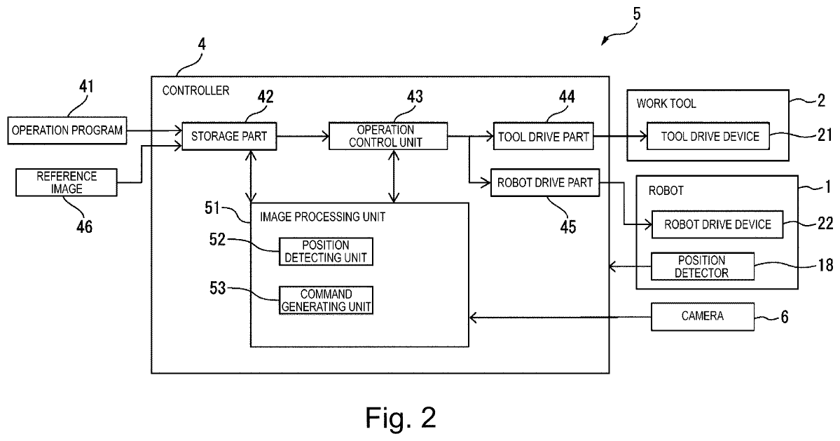

FIG. 2 is a block diagram of the robot apparatus according to the present embodiment. Referring to FIG. 1 and FIG. 2, the robot 1 includes a robot drive device 22 configured to change the position and the orientation of the robot 1. The robot drive device 22 includes drive motors configured to drive constituent members such as the arm, the wrist, and the like. A direction of each constituent member is changed by driving the robot drive device 22.

The robot apparatus 5 includes a tool drive device 21 configured to drive the work tool 2. The work tool 2 of the present embodiment is driven by air pressure. The tool drive device 21 of the present embodiment includes a cylinder, an electromagnetic valve, and the like.

The controller 4 controls operations of the robot 1 and the work tool 2. The controller 4 has an arithmetic processing device (computer) including a central processing unit (CPU) as a processor. The arithmetic processing device includes a random access memory (RAM), a read only memory (ROM), and the like, which are mutually connected to the CPU via a bus. The robot apparatus 5 of the present embodiment adjusts the relative positions of the holes of the workpiece 86 with respect to the holes of the workpiece 85 based on an operation program 41. The robot drive device 22 and the tool drive device 21 are controlled by the controller 4.

The controller 4 includes the storage part 42 for storing information relating to the control of the robot apparatus 5. The storage part 42 may be constituted by a non-transitory storage medium capable of storing information. For example, the storage part 42 may be constituted by a storage medium such as a volatile memory, a nonvolatile memory, a magnetic storage medium, or an optical storage medium. The operation program 41 is stored in the storage part 42.

An operation control unit 43 transmits an operation command for driving the robot 1 to a robot drive part 45 based on the operation program 41. The robot drive part 45 includes an electric circuit configured to drive the robot drive device 22. The robot drive part 45 supplies electricity to the robot drive device 22, based on the operation command.

Moreover, the operation control unit 43 transmits, to a tool drive part 44, an operation command for driving the work tool 2 based on the operation program 41. The tool drive part 44 includes an electric circuit configured to drive the tool drive device 21. The tool drive part 44 supplies electricity to the tool drive device 21, based on the operation command. The operation control unit 43 transmits, to the camera 6, an operation command for driving the camera 6, based on the operation program 41. The camera 6 captures an image based on the operation command.

The operation control unit 43 is equivalent to a processor driven in accordance with the operation program 41. The processor is configured to be able to read information stored in the storage part 42. The processor functions as the operation control unit 43 by reading the operation program 41 and performing control defined in the operation program 41.

The robot 1 includes a state detector for detecting the position and orientation of the robot 1. The state detector in the present embodiment includes a position detector 18 attached to the drive motor of the robot drive device 22 corresponding to the drive axis of the constituent member such as the arm. The position and the orientation of the robot 1 are calculated, based on the output of the position detector 18.

The controller 4 in the present embodiment includes an image processing unit 51 configured to process an image that is captured by the camera 6. The image processing unit 51 includes a position detecting unit 52 for detecting a three-dimensional position of a target portion based on the image acquired by the camera 6.

The position detecting unit 52 in the present embodiment detects the positions of the holes of the workpieces. As a position of the hole of the workpiece, for example, it is possible to detect the position of the center of a planar shape of the hole in a surface including the top face of the workpiece. In the present embodiment, the reference image 46 of the workpiece is stored in advance in the storage part 42. Alternatively, the reference image 46 of the hole of the workpiece is stored in advance in the storage part 42. The position detecting unit 52 can detect the position of the hole in the image by performing pattern matching on the image captured by the camera 6 by using the reference image 46.

In this case, a distance from the camera 6 to the workpiece 85 is measured in advance. Accordingly, the position detecting unit 52 can detect a three-dimensional position of the hole based on the position in the two-dimensional image that is captured by the camera 6. For example, in the camera coordinate system 39, the position of the center of the planar shape of the hole 85a of the workpiece 85 can be calculated. The camera coordinate system 39 of the present embodiment is fixed. The position and the orientation of the camera coordinate system 39 in the reference coordinate system 37 are predetermined. Therefore, the position detecting unit 52 can convert the position and orientation of the hole in the camera coordinate system 39 into the position and orientation of the hole in the reference coordinate system 37.

The image processing unit 51 includes a command generating unit 53 configured to generate an operation command for the robot 1 based on the position of the hole detected by the position detecting unit 52. For example, the command generating unit 53 generates an operation command so as to move the tool center point in the vertical direction after arranging the tool center point at the center position of the hole. The operation command generated by the command generating unit 53 is transmitted to the operation control unit 43. The operation control unit 43 drives the robot 1 and the work tool 2 based on the operation commands generated by the command generating unit 53.

Each of the image processing unit 51, the position detecting unit 52, and the command generating unit 53 is equivalent to a processor that is driven in accordance with a predetermined program. The processor functions as each unit by reading the program and performing control defined in the program.

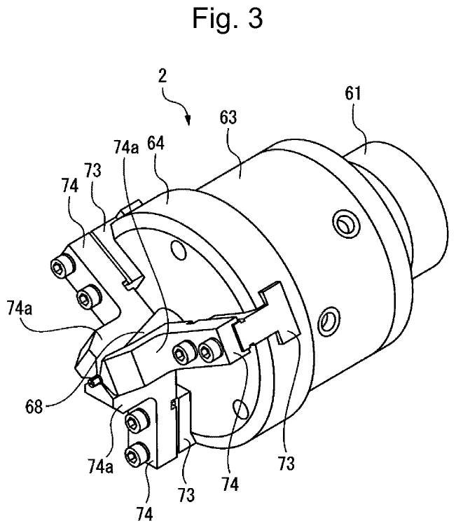

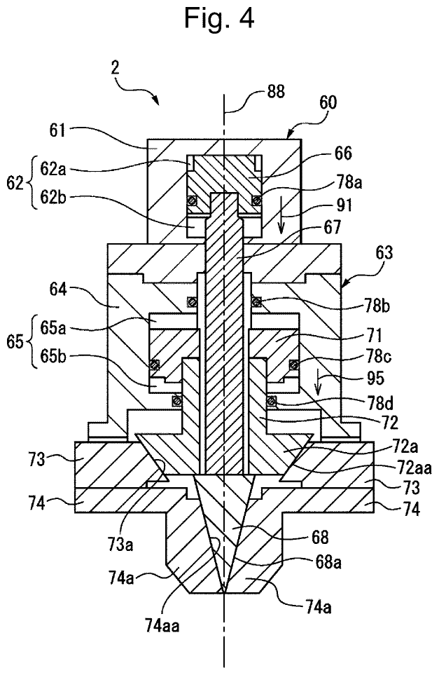

FIG. 3 illustrates a perspective view of the work tool in the present embodiment. FIG. 4 illustrates an enlarged schematic cross-sectional view of the work tool in the present embodiment. FIG. 4 is a cross-sectional view taken along a radial direction at the positions of a plurality of fingers. FIG. 4 illustrates a state of the work tool before the positioning of the holes is performed. In the present embodiment, a direction in which the pressing member 68 moves is referred to as an axial direction. A direction in which an axis 88 of a center axis extends is referred to as the axial direction. Further, a direction perpendicular to the axial direction is referred to as the radial direction.

The work tool 2 includes a plurality of fingers 74 formed to be movable in the radial direction. In the present embodiment, three fingers 74 are disposed. The finger 74 is fixed to a slide member 73. The slide member 73 is formed to be slidable in the radial direction relative to a second cylinder case 64. The finger 74 moves integrally with the slide member 73.

The work tool 2 includes the pressing member 68 for moving the plurality of fingers 74 in the radial direction. The pressing member 68 has a wedge-shaped cross section. The pressing member 68 in the present embodiment is formed in a conical shape. The pressing member 68 is disposed so as to be in contact with inner surfaces of the plurality of fingers 74.

Each finger 74 has an erected part 74a extending along the axis 88. The erected part 74a has an inclined surface 74aa on the inner side. The inclined surface 74aa is in close contact with an inclined surface 68a, which is an outer circumferential surface of the pressing member 68. The pressing member 68 has a shape that tapers in a direction toward a distal end of the erected part 74a. In this way, the pressing member 68 is pinched between the plurality of fingers 74 and is formed so as to be in close contact with inner circumferential surfaces of the plurality of fingers 74.

The work tool 2 is configured such that the fingers 74 open or close as the pressing member 68 moves in the direction of the axis 88. The work tool 2 includes a first cylinder 60 for moving the pressing member 68 in the axial direction and a second cylinder 63 for biasing the fingers 74. The first cylinder 60 includes a first cylinder case 61 having a hollow part 62 therein. A first piston 66 is disposed inside the hollow part 62. The first cylinder 60 functions as a movement device that moves the pressing member 68 in the axial direction.

The first piston 66 is connected to a first shaft 67. The pressing member 68 is fixed to the first shaft 67. Air chambers 62a and 62b for moving the first piston 66 are formed in the hollow part 62. When compressed air is supplied to one of the air chamber 62a and the air chamber 62b and air is discharged from the other air chamber (the air chamber is opened), the first piston 66 moves along the axis 88. The first piston 66, the first shaft 67, and the pressing member 68 move integrally.

The second cylinder 63 functions as a biasing device that biases the fingers 74 inward in the radial direction. The second cylinder 63 includes the second cylinder case 64 having a hollow part 65 therein. A second piston 71 is disposed inside the hollow part 65. A second shaft 72 is fixed to the second piston 71. The second piston 71 and the second shaft 72 are formed to be slidable in the axial direction relative to the first shaft 67. A distal end part 72a is formed at a distal end of the second shaft 72. The distal end part 72a of the present embodiment is formed in a truncated cone shape. The distal end part 72a has an inclined surface 72aa, which is an outer circumferential surface.

The second piston 71 and the second shaft 72 are formed so as to integrally move in the axial direction. The slide member 73 has an inclined surface 73a on the inner side in the radial direction. The inclined surface 72aa of the distal end part 72a is formed so as to be in contact with the inclined surface 73a of the slide member 73. The distal end part 72a includes a mechanism configured to catch the slide member 73 and bias the slide member 73 inward in the radial direction when the distal end part 72a moves in a direction away from the finger 74. In other words, the inclined surface 72aa of the distal end part 72a is formed to slide relative to the inclined surface 73a of the slide member 73 and engage with the inclined surface 73a so as to pull the slide member 73 inward in the radial direction.

In the hollow part 65 of the second cylinder case 64, when air is supplied to an air chamber 65b and air is discharged from an air chamber 65a, the second piston 71 and the second shaft 72 move in a direction away from the fingers 74. The slide members 73 and the fingers 74 are biased inward in the radial direction. In this way, the second piston 71 moves along the axial direction so that the fingers 74 can be biased.

A sealing member 78a configured to block the flow of air is disposed on the outer circumferential surface of the first piston 66. A sealing member 78b is disposed on the outer circumferential surface of the first shaft 67, a sealing member 78c is disposed on the outer circumferential surface of the second piston 71, and a sealing member 78d is disposed on the outer circumferential surface of the second shaft 72.

In a state illustrated in FIG. 4, compressed air is supplied to the air chamber 62b. The air chamber 62a is opened. Compressed air is supplied to the air chamber 65b. The air chamber 65a is opened. The first piston 66 moves in a direction away from the fingers 74. The pressing member 68 is disposed at a retracted position.

The second piston 71 is biased in a direction away from the fingers 74. The slide member 73 is pulled by the inclined surface 72aa of the distal end part 72a of the second shaft 72 and is biased inward in the radial direction. The finger 74 is biased inward together with the slide member 73 in the radial direction. The plurality of fingers 74 are in a closed state. The inclined surface 74aa of the erected part 74a is in close contact with the inclined surface 68a of the pressing member 68. In this state, the robot 1 is driven and inserts the erected parts 74a of the fingers 74 into the holes 85a and 86a.

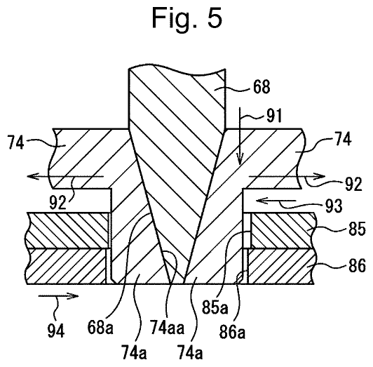

FIG. 5 illustrates an enlarged schematic cross-sectional view for explaining a step of aligning the positions of the holes. FIG. 5 corresponds to the state of the work tool in FIG. 4. The position of the hole 85a of the workpiece 85 and the position of the hole 86a of the workpiece 86 are slightly displaced from each other in the radial direction. In this example, the position of the hole 85a and the position of the hole 86a are displaced from each other in the horizontal direction.

The controller 4 inserts the erected parts 74a of the fingers 74 into the hole 85a and the hole 86a. As described above, the position detecting unit 52 of the controller 4 can detect the position of the hole 85a by analyzing the image of the top face of the workpiece 85 captured by the camera 6. Then, the command generating unit 53 drives the robot 1 so that the tool center point of the work tool 2 is arranged at the position of the hole 85a. For example, the distal end point of the pressing member 68 is arranged at the center position of the hole 85a on the top face of the workpiece 85. Subsequently, the command generating unit 53 can insert the erected parts 74a of the fingers 74 into the holes 85a and 86a by moving the work tool 2 downward in the vertical direction.

Alternatively, in the present embodiment, positions at which the workpieces 85 and 86 are arranged with respect to the platforms 81 and 82 are determined in advance. Accordingly, the positions of the holes 85a and 86a are determined in advance although errors are included. The storage part 42 of the controller 4 can store the position and the orientation of the robot when the erected parts 74a of the work tool 2 are inserted into the holes 85a and 86a. Then, by the controller 4 driving the robot 1, the erected parts 74a at the distal end of the work tool 2 are inserted into the holes 85a and 86a.

Referring to FIG. 4, in a state where the fingers 74 are inserted into the holes 85a and 86a of the plurality of workpieces 85, 86, the tool drive device 21 removes air from the air chamber 62b and supplies compressed air to the air chamber 62a of the first cylinder 60. The tool drive device 21 performs control for removing air from the air chamber 65b of the second cylinder 63. By performing this control, the first piston 66, the first shaft 67, and the pressing member 68 move in a direction indicated by an arrow 91. The second piston 71 and the second shaft 72 move in a direction indicated by an arrow 95.

Referring to FIG. 5, the pressing member 68 moves in the direction indicated by the arrow 91. The inclined surface 68a of the pressing member 68 presses the inclined surface 74aa of the finger 74. The finger 74 moves outward in the radial direction as indicated by an arrow 92. In this way, the plurality of fingers 74 perform an opening operation.

When the finger 74 moves in the direction indicated by the arrow 92, the outer surface in the radial direction of the erected part 74a comes into contact with the holes 85a and 86a. In this example, the workpiece 85 moves in a direction indicated by an arrow 93. The workpiece 86 moves in a direction indicated by an arrow 94. The workpieces 85 and 86 are not fixed to an anchoring member but are set on the platforms. Therefore, the relative position of the workpiece 86 with respect to the workpiece 85 changes in accordance with the movement of the fingers 74.

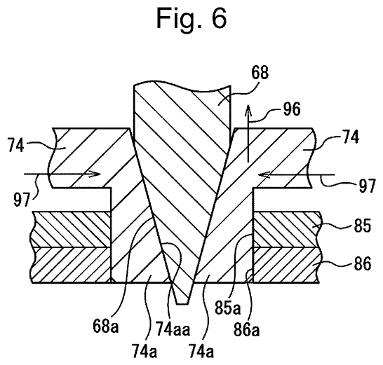

FIG. 6 illustrates an enlarged schematic cross-sectional view when the fingers are opened. When the fingers 74 are opened, the outer circumferential surfaces of the fingers 74 come into contact with the holes 85a and 86a. Since the fingers 74 are driven by a predetermined driving force, the opening operation of the fingers 74 is stopped. The position of the hole 85a and the position of the hole 86a are aligned along the axial direction. In other words, in a plan view, the position of the hole 85a and the position of the hole 86a match each other. Alignment of the positions of the holes with each other is completed.

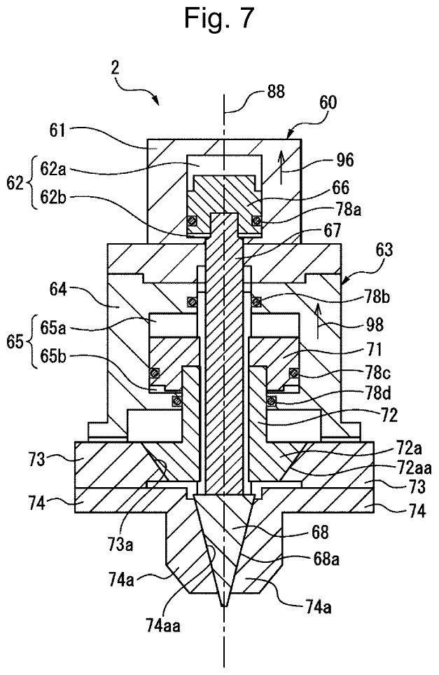

FIG. 7 is a schematic cross-sectional view of the work tool when the alignment of the positions of the holes with each other is completed. Referring to FIG. 6 and FIG. 7, when compressed air is supplied to the air chamber 62a of the first cylinder 60, the first piston 66, the first shaft 67, and the pressing member 68 are arranged at the positions causing the pressing member 68 to protrude most. When the air chamber 65b of the second cylinder 63 is opened, the positions of the second piston 71 and the second shaft 72 are changed as the fingers 74 move outward in the radial direction.

Referring to FIG. 6 and FIG. 7, after the alignment of the positions of the holes with each other is completed, the tool drive device 21 performs an operation of supplying compressed air to the air chamber 62b of the first cylinder 60 and removing air from the air chamber 62a. This operation causes the first piston 66, the first shaft 67, and the pressing member 68 to move in a direction indicated by an arrow 96.

In the second cylinder 63, by removing air from the air chamber 65a and supplying compressed air to the air chamber 65b, the second piston 71 and the second shaft 72 are biased in a direction indicated by an arrow 98. The slide member 73 and the finger 74 are moved inward in the radial direction as indicated by an arrow 97 by the movement of the second shaft 72. The slide member 73 and the finger 74 are biased inward in the radial direction by the movement of the second shaft 72. By performing the control, the plurality of fingers 74 are closed and separated from the inner circumferential surfaces of the holes 85a and 86b.

After the fingers 74 are separated from the inner circumferential surfaces of the holes 85a and 86a, the controller 4 controls the position and the orientation of the robot 1 such that the work tool 2 is retracted from the workpieces 85 and 86. After the holes 85a and 86a are subjected to position alignment, a bolt, a pin, or the like can be inserted into the holes 85a and 86a.

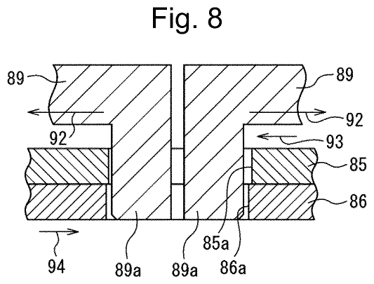

FIG. 8 illustrates an enlarged schematic cross-sectional view of a distal end part of a positioning device of a comparative example. The positioning device of the comparative example includes fingers 89, which move together in the radial direction. The fingers 89 are formed to be moved by a chuck device. In other words, the finger 89 is not pressed by a wedge-shaped pressing member but is connected to a cylinder or the like and moved in the radial direction.

In the positioning device of the comparative example, the chuck device is driven so as to move the finger 89 in the direction indicated by the arrow 92. Then, an erected part 89a is brought into contact with the holes 85a and 85b, thereby making it possible to align the positions of the holes 85a and 86a.

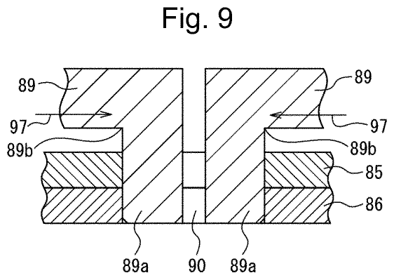

FIG. 9 is an enlarged schematic cross-sectional view when the position alignment of the holes is completed in the positioning device of the comparative example. In the positioning device of the comparative example, a space 90 is formed between a plurality of the fingers 89. Referring to FIG. 8 and FIG. 9, the finger 89 is driven in the direction indicated by the arrow 92.

When the erected part 89a of the finger 89 comes into contact with the inner circumferential surfaces of the holes 85a and 86a, stress is applied in a direction in which the finger 89 bends. In particular, the stress is applied to a portion 89b of the finger 89 in the direction in which the finger 89 bends. For this reason, there is a problem that the durability of the finger 89 is lowered. When the finger 89 is deformed, broken, or the like, the finger 89 needs to be replaced. Alternatively, there is a problem that a force larger than an allowable bending moment cannot be applied to a guide part supporting the finger 89 of the chuck device.

Referring to FIG. 5 and FIG. 6, on the other hand, in the positioning device of the present embodiment, the pressing member 68 is disposed in a region surrounded by the plurality of fingers 74. The finger 74 is in contact with the pressing member 68. Because of this, when the finger 74 is driven, it is possible to suppress a situation in which bending stress is applied to the finger 74. As a result, the positioning device of the present embodiment is unlikely to be broken. In other words, the durability of the positioning device is improved.

In the present embodiment, the plurality of fingers 74 are formed so as to move outward in the radial direction when the movement device including the first cylinder 60 pushes the pressing member 68, but the present disclosure is not limited thereto. The movement device may be configured such that, by pulling the pressing member 68, the pressing member 68 moves in the direction indicated by the arrow 91.

In the present embodiment, the pressing member 68 is configured to be moved by the first cylinder 60, but the present disclosure is not limited thereto. The movement device may be formed so as to move the pressing member 68 by a member such as a motor or a spring. The biasing device configured to bias the finger 74 inward in the radial direction is not limited to the second cylinder 63. The biasing device may be configured to bias the finger inward in the radial direction by a member such as a motor or a spring.

Next, another control for inserting fingers of a work tool into holes of workpieces will be described. Referring to FIG. 1 and FIG. 2, the controller 4 includes the image processing unit 51 configured to process an image of the camera 6. In the case of the aforesaid another control, the camera 6 images the workpiece 85 and the workpiece 86 so as to detect the position of the hole 85a and the position of the hole 86a.

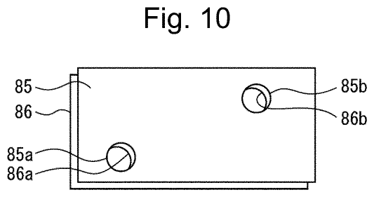

FIG. 10 illustrates a plan view of a plurality of workpieces of the present embodiment. When two workpieces 85 and 86 are set on the top face of the platform 82, the positions of the two workpieces 85 and 86 may be slightly displaced from each other. In this example, the position of the hole 86a is displaced relative to the hole 85a. In addition, the position of the hole 86b is displaced relative to the hole 85b.

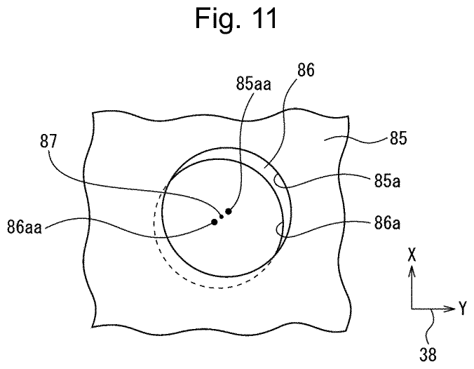

FIG. 11 illustrates an enlarged view of holes in an image that is captured by a camera. FIG. 11 illustrates an enlarged view of the image of the hole 85a and the hole 86a. Referring to FIG. 2, FIG. 10, and FIG. 11, the position detecting unit 52 of the image processing unit 51 detects a center point 85aa of the hole 85a in a plan view by pattern matching of the hole 85a. The image of the camera 6 includes an arc of the hole 86a of the workpiece 86. The position detecting unit 52 can detect a center point 86aa of the hole 86a in the image by detecting the arc.

The position detecting unit 52 converts the coordinate values of the camera coordinate system 39 into the coordinate values of the reference coordinate system 37. On the top face of the workpiece 85, the position of the center point 85aa and the position of the center point 86aa can be calculated. The command generating unit 53 calculates a midpoint 87 between the center point 85aa and the center point 86aa. Then, the command generating unit 53 can control the position and orientation of the robot 1 so that the tool center point of the work tool 2 is arranged at the position of the midpoint 87 on the top face of the workpiece 85. Subsequently, the position and orientation of the robot can be controlled so that the tool center point of the work tool 2 moves downward in the vertical direction. By performing the control, the erected part 74a of the finger 74 of the work tool 2 can be reliably inserted into the plurality of holes 85a, 86a.

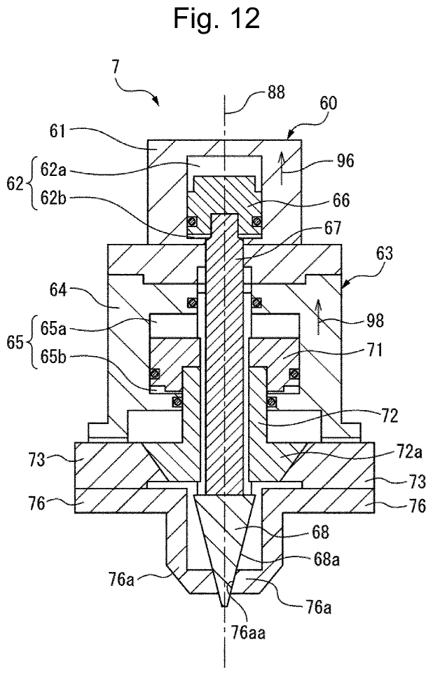

FIG. 12 illustrates a schematic cross-sectional view of another work tool in the present embodiment. In the above-described work tool 2, most of the inner surface of the finger 74 is in contact with the outer circumferential surface of the pressing member 68, but the present disclosure is not limited thereto. Another work tool 7 of the present embodiment includes a finger 76 having an erected part 76a. Most of the inner circumferential surface of the erected part 76a is not in contact with the pressing member 68. Part of an inclined surface 76aa of the erected part 76a is formed so as to be in contact with the inclined surface 68a of the pressing member 68.

With the configuration of the aforesaid another work tool 7 as well, since the pressing member 68 is disposed in a portion surrounded by a plurality of the fingers 76, it is possible to avoid a situation in which bending stress is applied to the fingers 76. As a result, the durability of the work tool 7 can be improved.

The positioning device of the present embodiment has three fingers, but the present disclosure is not limited thereto. The positioning device may be constituted by the plurality of fingers. The pressing member of the present embodiment has a conical shape, but the shape of the pressing member is not limited thereto. The pressing member may have a pyramid shape corresponding to the number of fingers.

The camera 6 as a vision sensor of the present embodiment is fixed to the support member 83, but the present disclosure is not limited thereto. The vision sensor can be disposed such that the image of the workpiece can be captured. For example, the vision sensor may be fixed to the wrist so as to move integrally with the wrist of the robot. In this case, the position and orientation in the camera coordinate system of the robot can be calculated in advance. Then, based on the position and orientation of the robot, information on the position of the hole detected in the camera coordinate system can be converted into information on the position of the hole in the reference coordinate system.

The camera 6 of the present embodiment is a two-dimensional camera, but is not limited thereto. The vision sensor may be a three-dimensional camera capable of acquiring three-dimensional position information. The vision sensor may be, for example, a stereo camera including two two-dimensional cameras.

In the present embodiment, the controller includes the image processing unit, but the present disclosure is not limited thereto. The image processing unit may be constituted by an arithmetic processing device (computer) different from the controller that controls the operations of the robot. For example, a computer that functions as the image processing unit may be formed so as to communicate with the controller that controls the robot.

In the present embodiment, the control for aligning the positions of the holes of two workpieces has been described as an example. However, the present disclosure is not limited thereto, and a case of hole position alignment of three or more workpieces can also be implemented similarly to the control of the present embodiment.

According to at least one of the embodiments described above, it is possible to provide a positioning device for aligning the positions of holes of a plurality of workpieces with each other.

The present disclosure has been described in detail thus far, but the present disclosure is not limited to the individual embodiments described above. Various additions, replacements, changes, partial deletions, and the like can be made to these embodiments without departing from the gist of the present disclosure or without departing from the gist of the present disclosure derived from the contents described in the claims and equivalents thereof. Further, these embodiments can also be combined and implemented. For example, in the above-described embodiment, the order of the operations and the order of the processes are given as examples, and are not limited thereto. The same applies to a case where a numerical value or a mathematical expression is used in the description of the above-described embodiment.

The following supplementary notes are disclosed with regard to the above-described embodiment and modified examples.

### Supplementary Note 1

A positioning device including:
the plurality of fingers 74, 76 formed to be movable in a radial direction perpendicular to an axial direction;
the pressing member 68 having a wedge shape and disposed so as to be in contact with the plurality of fingers; and
the movement device 60 configured to move the pressing member in the axial direction, wherein
when the movement device moves the pressing member in a state in which the fingers are inserted into the holes 85a and 86a of the plurality of workpieces 85, 86, the fingers move outward in a radial direction to align positions of the holes of the plurality of workpieces.

### Supplementary Note 2

The positioning device of Supplementary Note 1, wherein
each of the plurality of fingers includes the erected part 74a, 76a extending in the axial direction,
the pressing member is formed to taper in a direction toward a distal end of the erected part, and
the plurality of fingers move outward in the radial direction when the movement device pushes the pressing member.

### Supplementary Note 3

The positioning device of Supplementary Note 1 or Supplementary Note 2, further including the biasing device 63 configured to bias each of the plurality of fingers inward in the radial direction.

### REFERENCE SIGNS LIST

2, 7 Work tool
60 First cylinder
63 Second cylinder
66 First piston
67 First shaft
68 Pressing member
71 Second piston
72 Second shaft
74, 76 Finger
74a, 76a Erected part
85, 86 Workpiece
85a, 85b, 86a, 86b Hole
88 Axis

What is claimed is:

1. A positioning device comprising:
a plurality of fingers formed to be movable in a radial direction perpendicular to an axial direction;
a pressing member having a wedge shape and disposed so as to be in contact with the plurality of fingers; and
a movement device configured to move the pressing member in the axial direction, wherein
when the movement device moves the pressing member in a state in which the fingers are inserted into holes of a plurality of workpieces, the fingers move outward in a radial direction to align positions of the holes of the plurality of workpieces.

2. The positioning device of claim 1, wherein
each of the plurality of fingers includes an erected part extending in the axial direction,
the pressing member is formed to taper in a direction toward a distal end of the erected part, and
the plurality of fingers move outward in the radial direction when the movement device pushes the pressing member.

3. The positioning device of claim 1, comprising a biasing device configured to bias each of the plurality of fingers inward in the radial direction.
